(19) United States
(12) Patent Application Publication
(10) Pub. No.: US 2015/0002454 A1
(43) Pub. Date: Jan. 1, 2015

(54) QUICK RESPONSE CAPACITIVE TOUCH SCREEN DEVICES

(71) Applicant: Kaining Yuan, Shanghai (CN)

(72) Inventor: Kaining Yuan, Shanghai (CN)

(21) Appl. No.: 14/125,239

(22) PCT Filed: Jul. 1, 2013
(86) PCT No.: PCT/CN2013/078571

§ 371 Date: Dec. 10, 2013

(51) Int. Cl. G06F 3/044

(52) U.S. Cl. CPC G06F 3/044
USPC 345/174

(57) ABSTRACT

Systems and methods may provide for identifying a pre-touch condition with respect to a touch screen and loading preliminary data associated with the pre-touch condition into a software stack. Additionally, the preliminary data may be used to trigger a touch event if a touch condition is identified with respect to the touch screen. In one example, the preliminary data may be prevented from being represented in an user interface associated with the software stack.

### TECHNICAL FIELD

Embodiments generally relate to touch screen devices. More particularly, embodiments relate to quick response capacitive touch screen devices.

### BACKGROUND

Touch screens may be used to perform various user interface (UI) based functions such as cursor movement, scrolling operations and zoom operations on computing platforms. Traditionally, a finger coming into contact with a panel of the touch screen may initiate software reactions such as reading hardware data from the touch screen, creating new software data structures and notifying various software layers that support the UI based functions. Indeed, the software layers may in turn create more data structures. The time required for these software reactions to take place may significantly slow down the response time of the touch screen device and lead to a sub-optimal user experience.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a pre-touch condition according to an embodiment;

FIG. 2 is a block diagram of an example of an approach to loading preliminary data associated with a pre-touch condition into a software stack according to an embodiment;

FIG. 3 is an illustration of an example of an approach to identifying a pre-touch condition according to an embodiment;

FIG. 4 is a flowchart of an example of a method of triggering touch events according to an embodiment; and

FIG. 5 is block diagram of an example of a system according to an embodiment.

### DESCRIPTION OF EMBODIMENTS

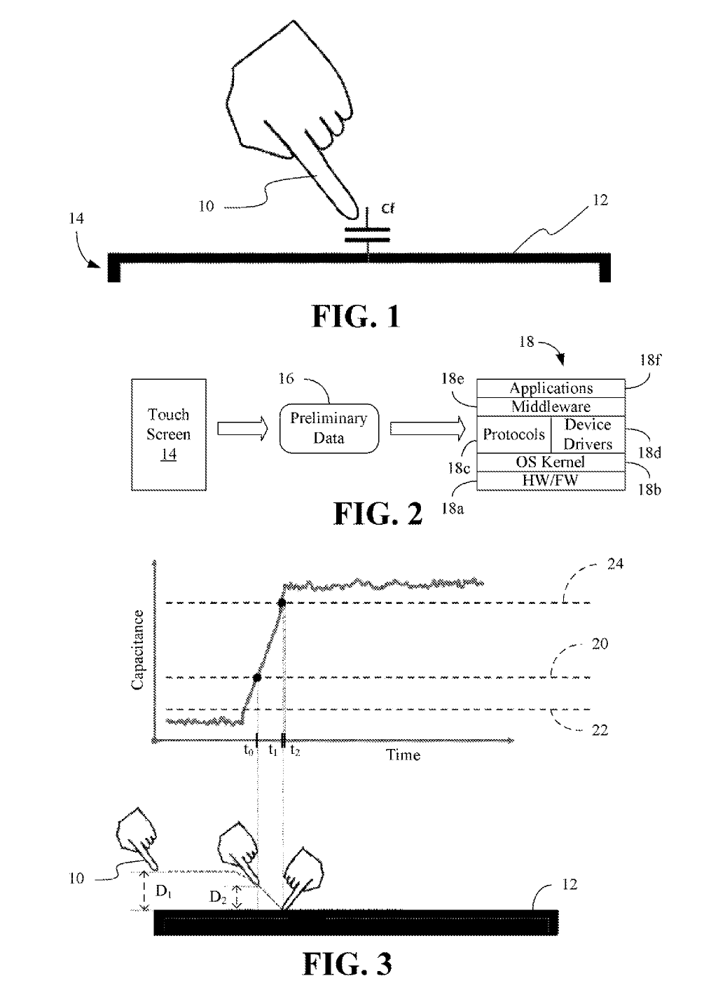

Turning now to FIG. 1, a pre-touch condition scenario is shown in which a finger 10 of a user comes within proximity of a capacitive panel 12 of a touch screen 14. In the illustrated example, prior to the finger 10 actually coming into contact with the panel 12 of the touch screen 14, a change in capacitance C_{f} between the finger 10 and the panel 12 may be detected. As will be discussed in greater detail, identifying the illustrated pre-touch condition and leveraging preliminary data associated with the pre-touch condition may enable the response time of the touch screen 14 to be significantly reduced.

For example, FIG. 2 demonstrates an approach in which preliminary data 16 associated with a pre-touch condition is loaded into a software stack 18 (18a-18f) before the finger of the user actually comes into contact with the touch screen. The preliminary data 16 may include, for example, X-Y coordinate data, capacitance values, and so forth. Loading the preliminary data 16 into the software stack 18 may enable certain processing functions such as, for example, reading the preliminary data 16 from the touch screen 14, creating new software data structures and notifying various software layers that support user interface (UI) based functions to be conducted prior to detection of an actual touch condition with respect to the touch screen 14.

Of particular note is that the preliminary data 16 may be prevented from being represented in the UI until a verified touch condition occurs. Such an approach may avoid false positives that might occur if a subsequent touch condition does not follow the pre-touch condition. Nevertheless, substantial advantages may be realized by enabling layers in the software stack 18 such as, for example, an operating system (OS) kernel layer 18b and/or an application layer 18f to pre-process the preliminary data 16 and prepare for potential touch events in advance of their occurrence. Other layers such as a hardware (HW)/firmware (FW) layer 18a, a protocol layer 18c, a device driver layer 18d and/or a middleware layer 18e may have frameworks that benefit from the preliminary data 16. Prevention of the preliminary data 16 from being presented in the UI may be achieved by notifying one or more layers in the software stack 18 that the preliminary data 16 is associated with a pre-touch condition rather than a touch condition. For example, upon receipt of such a notification, a service in the application layer 18f might create the appropriate data structure to translate the received coordinates into an appropriate JAVA SCRIPT object, method and/or operation, but refrain from completing the processing of the preliminary data 16 through the UI of the service until notification of a touch condition and/or event has been received.

FIG. 3 demonstrates that substantial performance advantages may be obtained via the pre-touch techniques described herein. In general, an equivalent capacitance curve is shown over time for a scenario in which a user interacts with the panel 12 of a touch screen. More particularly, a pre-touch threshold 20 may be established, wherein the pre-touch threshold 20 is greater than a noise threshold 22 and less than a touch threshold 24. In the illustrated example, the finger 10 is initially at a distance D₁ that results in a capacitance value that is below the noise threshold 22. Accordingly, the touch screen panel 12 may be deemed to be idle during the illustrated time period before time t₀. At time t₀, however, the illustrated finger 10 comes within sufficient proximity (e.g., at a distance D₂) of the touch screen panel 12 to cause the capacitance value to exceed the pre-touch threshold 20. Thus, at time t₀, preliminary data (e.g., coordinate data, capacitance values) associated with the pre-touch condition may be loaded at time t₀ into a software stack associated with the touch screen panel 12, wherein loading the preliminary data may enable one or more layers of the software stack to prepare for a subsequent touch condition.

In the illustrated example, the finger 10 comes into contact with the touch screen panel 12 at time t₁, causing the capacitance value to exceed the touch threshold 24 and a touch condition to be identified. Because the preliminary data was previously loaded in response to the pre-touch condition, a touch event may be triggered at time t₂, which may effectively be the same time as time t₁ (or negligibly different). Thus, the illustrated solution enables the touch event to be triggered nearly concurrently with the actual touch condition. By contrast, under a conventional solution, no processing might occur at time t₀ and a substantial amount of time may exist between times t₁ and t₂.

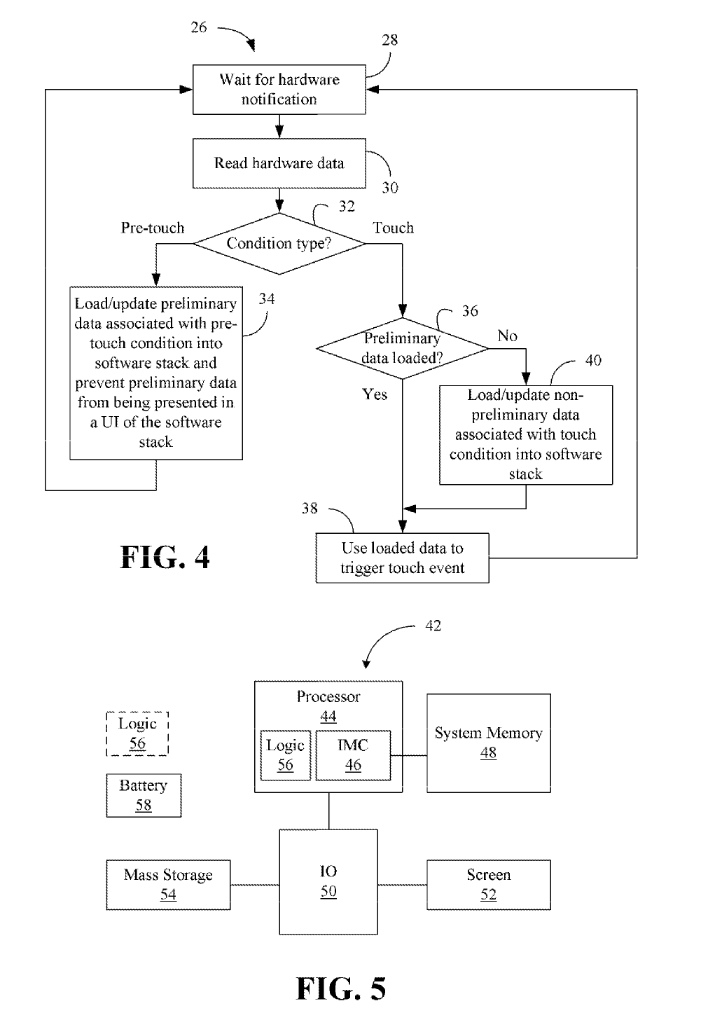

Turning now to FIG. 4, a method 26 of triggering touch events is shown. The method 26 may be implemented as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 26 may be written in any combination of one or more programming languages, including an object oriented programming language such as Java, Smalltalk, C++ or the like and conventional procedural programming languages, such as the “C” programming language or similar programming languages.

Illustrated processing block 28 provides for waiting for a hardware notification from a touch screen such as, for example, the touch screen 14 (FIG. 1). In one example, the hardware notice is an interrupt request (IRQ) that may be handled by an OS kernel routine. Hardware data (e.g., coordinate data, capacitance values) may be read from the touch screen at block 30 in response to the hardware notification, wherein illustrated block 32 determines the type of condition giving rise to the hardware notification. The determination at block 32 may therefore involve identifying the type of hardware notification.

In this regard, hardware and/or firmware associated with the touch screen may generally be configured to determine whether a pre-touch threshold or a touch threshold has been exceeded. Thus, generation of the hardware notification may involve comparing one or more capacitance values to the thresholds. If the comparison is conducted by hardware, a set of two hardware comparators might be used. If the comparison is conducted by firmware, one hardware comparator may be sufficient. Using firmware to determine whether the pre-touch threshold or the touch threshold has been exceeded may be advantageous in that the firmware may be a separate routine that does not occupy the host processor time, nor the running-processes, schedule, etc., of the OS or other software.

If a pre-touch condition is identified, the hardware data, which may be considered preliminary data associated with the pre-touch condition, may be loaded into a software stack and/or updated at block 34. Loading the preliminary data into the software stack may involve, for example, writing the preliminary data to one or more registers and/or memory locations that are exposed to the software stack. Updating the preliminary data might occur if the identified pre-touch condition is subsequent to a previous pre-touch condition. In such a case, the most recent preliminary data may be used to overwrite or supplement previously loaded preliminary data in the appropriate registers and/or memory locations. The loaded and/or updated preliminary data may be prevented from being represented in a UI associated with the software stack by, for example, notifying one or more layers of the software stack that the data is preliminary in nature. The layers may therefore cooperate in keeping the preliminary data hidden from the user's perspective.

If, on the other hand, it is determined at block 32 that a touch condition has been identified (e.g., touch threshold has been exceeded, touch hardware notification has been received), illustrated block 36 determines whether preliminary data has already been loaded for the touch condition. Thus, the determination at block 36 might involve determining whether the preliminary data is sufficiently recent (e.g., appropriate timer has not expired). If preliminary data has already been loaded, the loaded data may be immediately used at block 38 to trigger a touch event. Otherwise, the hardware data, which may be considered non-preliminary data associated with the touch condition, may be loaded into the software stack and/or updated at block 40. As with the preliminary data, loading the non-preliminary data may involve writing coordinate data and/or capacitance values to one or more registers and/or memory locations that are exposed to the software stack. Bypassing block 40 may enable a substantial decrease in response time and improvement of performance.

FIG. 5 shows a system 42. The system 42 may be part of a mobile platform having computing functionality (e.g., personal digital assistant/PDA, laptop, smart tablet), communications functionality (e.g., wireless smart phone), imaging functionality, media playing functionality (e.g., smart television/TV), or any combination thereof (e.g., mobile Internet device/MID). In the illustrated example, the system 42 includes a battery 58 to supply power to the system and a processor 44 having an integrated memory controller (IMC) 46, which may communicate with system memory 48. The system memory 48 may include, for example, dynamic random access memory (DRAM) configured as one or more memory modules such as, for example, dual inline memory modules (DIMMs), small outline DIMMs (SODIMMs), etc.

The illustrated system 42 also includes a input output (IO0) module 50, sometimes referred to as a Southbridge of a chipset, that functions as a host device and may communicate with, for example, a touch screen 52 and mass storage 54 (e.g., hard disk drive/HDD, optical disk, flash memory, etc.). The illustrated processor 44 may execute logic 56 that is configured to identify pre-touch conditions with respect to the touch screen 52, load preliminary data associated with the pre-touch conditions into a software stack, and use the preliminary data to trigger touch events if touch conditions are identified with respect to the touch screen 52. The logic 56 may alternatively be implemented external to the processor 44. Additionally, the processor 44 and the 10 module 50 may be implemented together on the same semiconductor die as a system on chip (SoC).

### Additional Notes and Examples

Example 1 may include a system to manage touch events, comprising a battery to provide power to the system, a touch screen, and logic, implemented at least partially in fixed-functionality hardware, to, identify a pre-touch condition with respect to the touch screen, load preliminary data associated with the pre-touch condition into a software stack, and use the preliminary data to trigger a touch event if a touch condition is identified with respect to the touch screen.

Example 2 may include the system of Example 1, wherein the logic is to prevent the preliminary data from being represented in a user interface associated with the software stack.

Example 3 may include the system of Example 1, wherein the preliminary data is to be loaded into one of an operating system layer or an application layer of the software stack.

Example 4 may include the system of any one of Examples 1 to 3, wherein the logic is to update the preliminary data based on one or more of the touch condition or a subsequent pre-touch condition.

Example 5 may include the system of any one of Examples 1 to 3, wherein the logic is to determine that a capacitance value of the touch screen has exceeded a pre-touch threshold to identify the pre-touch condition.

Example 6 may include the system of Example 5, wherein the pre-touch threshold is to be greater than a noise threshold and less than a touch threshold corresponding to the touch condition.

Example 7 may include an apparatus to manage touch events, comprising logic, implemented at least partly in fixed-functionality hardware, to, identify a pre-touch condition with respect to a touch screen, load preliminary data associated with the pre-touch condition into a software stack, and use the preliminary data to trigger a touch event if a touch condition is identified with respect to the touch screen.

Example 8 may include the apparatus of Example 7, wherein the logic is to prevent the preliminary data from being represented in a user interface associated with the software stack.

Example 9 may include the apparatus of Example 7, wherein the preliminary data is to be loaded into one of an operating system layer or an application layer of the software stack.

Example 10 may include the apparatus of any one of Examples 7 to 9, wherein the logic is to update the preliminary data based on one or more of the touch condition or a subsequent pre-touch condition.

Example 11 may include the apparatus of any one of Examples 7 to 9, wherein the logic is to determine that a capacitance value of the touch screen has exceeded a pre-touch threshold to identify the pre-touch condition.

Example 12 may include the apparatus of Example 11, wherein the pre-touch threshold is to be greater than a noise threshold and less than a touch threshold corresponding to the touch condition.

Example 13 may include a method of managing touch events, comprising identifying a pre-touch condition with respect to a touch screen, loading preliminary data associated with the pre-touch condition into a software stack, and using the preliminary data to trigger a touch event if a touch condition is identified with respect to the touch screen.

Example 14 may include the method of Example 13, further including preventing the preliminary data from being represented in a user interface associated with the software stack.

Example 15 may include the method of Example 13, wherein the preliminary data is loaded into one or more of an operating system layer or an application layer of the software stack.

Example 16 may include the method of any one of Examples 13 to 15, further including updating the preliminary data based on one or more of the touch condition or a subsequent pre-touch condition.

Example 17 may include the method of any one of Examples 13 to 15, wherein identifying the pre-touch condition includes determining that a capacitance value of the touch screen has exceeded a pre-touch threshold.

Example 18 may include the method of Example 17, wherein the pre-touch threshold is greater than a noise threshold and less than a touch threshold corresponding to the touch condition.

Example 19 may include a non-transitory computer readable storage medium comprising a set of instructions which, if executed by a device, cause the device to identify a pre-touch condition with respect to a touch screen, load preliminary data associated with the pre-touch condition into a software stack, and use the preliminary data to trigger a touch event if a touch condition is identified with respect to the touch screen.

Example 20 may include the medium of Example 19, wherein the instructions, if executed, cause a device to prevent the preliminary data from being represented in a user interface associated with the software stack.

Example 21 may include the medium of Example 19, wherein the preliminary data is to be loaded into one of an operating system layer or an application layer of the software stack.

Example 22 may include the medium of any one of Examples 19 to 21, wherein the instructions, if executed, cause a device to update the preliminary data based on one or more of the touch condition or a subsequent pre-touch condition.

Example 23 may include the medium of any one of Examples 19 to 21, wherein the instructions, if executed, cause a device to determine that a capacitance value of the touch screen has exceeded a pre-touch threshold to identify the pre-touch condition.

Example 24 may include the medium of Example 23, wherein the pre-touch threshold is to be greater than a noise threshold and less than a touch threshold corresponding to the touch condition.

Example 25 may include an apparatus to manage touch events, comprising means for identifying a pre-touch condition with respect to a touch screen, means for loading preliminary data associated with the pre-touch condition into a software stack, and means for using the preliminary data to trigger a touch event if a touch condition is identified with respect to the touch screen.

Example 26 may include the apparatus of Example 25, further including means for preventing the preliminary data from being represented in a user interface associated with the software stack.

Example 27 may include the apparatus of Example 26, wherein the preliminary data is to be loaded into one of an operating system layer or an application layer of the software stack.

Example 28 may include the apparatus of any one of Examples 25 to 27, further including means for updating the preliminary data based on one or more of the touch condition or a subsequent pre-touch condition.

Example 29 may include the apparatus of any one of Examples 25 to 27, further including means for determining that a capacitance value of the touch screen has exceeded a pre-touch threshold to identify the pre-touch condition.

Example 30 may include the apparatus of Example 29, wherein the pre-touch threshold is to be greater than a noise threshold and less than a touch threshold corresponding to the touch condition.

Thus, techniques described herein may track finger movements relative to a touch screen before the finger has actually landed on the touch-screen surface. As a result, various software layers may be ready to trigger touch events based on the tracked preliminary data. Accordingly, substantial performance improvements may be achieved. Such improvements may be particularly advantageous in game applications and other UI based applications in which response time is an area of concern.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-25. (canceled)

26. A system comprising:
a touch screen; and
logic, implemented at least partly in fixed-functionality hardware, to,
identify a pre-touch condition with respect to the touch screen,
load preliminary data associated with the pre-touch condition into a software stack, and
use the preliminary data to trigger a touch event if a touch condition is identified with respect to the touch screen.

27. The system of claim 26, wherein the logic is to prevent the preliminary data from being represented in a user interface associated with the software stack.

28. The system of claim 26, wherein the preliminary data is to be loaded into one of an operating system layer or an application layer of the software stack.

29. The system of claim 26, wherein the logic is to update the preliminary data based on one or more of the touch condition or a subsequent pre-touch condition.

30. The system of claim 26, wherein the logic is to determine that a capacitance value of the touch screen has exceeded a pre-touch threshold to identify the pre-touch condition.

31. The system of claim 30, wherein the pre-touch threshold is to be greater than a noise threshold and less than a touch threshold corresponding to the touch condition.

32. An apparatus comprising:
logic, implemented at least partly in fixed-functionality hardware, to,
identify a pre-touch condition with respect to a touch screen,
load preliminary data associated with the pre-touch condition into a software stack, and
use the preliminary data to trigger a touch event if a touch condition is identified with respect to the touch screen.

33. The apparatus of claim 32, wherein the logic is to prevent the preliminary data from being represented in a user interface associated with the software stack.

34. The apparatus of claim 32, wherein the preliminary data is to be loaded into one of an operating system layer or an application layer of the software stack.

35. The apparatus of claim 32, wherein the logic is to update the preliminary data based on one or more of the touch condition or a subsequent pre-touch condition.

36. The apparatus of claim 32, wherein the logic is to determine that a capacitance value of the touch screen has exceeded a pre-touch threshold to identify the pre-touch condition.

37. The apparatus of claim 36, wherein the pre-touch threshold is to be greater than a noise threshold and less than a touch threshold corresponding to the touch condition.

38. A method comprising:
identifying a pre-touch condition with respect to a touch screen;
loading preliminary data associated with the pre-touch condition into a software stack; and
using the preliminary data to trigger a touch event if a touch condition is identified with respect to the touch screen.

39. The method of claim 38, further including preventing the preliminary data from being represented in a user interface associated with the software stack.

40. The method of claim 38, wherein the preliminary data is loaded into one or more of an operating system layer or an application layer of the software stack.

41. The method of claim 38, further including updating the preliminary data based on one or more of the touch condition or a subsequent pre-touch condition.

42. The method of claim 38, wherein identifying the pre-touch condition includes determining that a capacitance value of the touch screen has exceeded a pre-touch threshold.

43. The method of claim 42, wherein the pre-touch threshold is greater than a noise threshold and less than a touch threshold corresponding to the touch condition.

44. A non-transitory computer readable storage medium comprising a set of instructions which, if executed by a device, cause the device to:
identify a pre-touch condition with respect to a touch screen;
load preliminary data associated with the pre-touch condition into a software stack; and
use the preliminary data to trigger a touch event if a touch condition is identified with respect to the touch screen.

45. The medium of claim 44, wherein the instructions, if executed, cause a device to prevent the preliminary data from being represented in a user interface associated with the software stack.

46. The medium of claim 44, wherein the preliminary data is to be loaded into one of an operating system layer or an application layer of the software stack.

47. The medium of claim 44, wherein the instructions, if executed, cause a device to update the preliminary data based on one or more of the touch condition or a subsequent pre-touch condition.

48. The medium of claim 44, wherein the instructions, if executed, cause a device to determine that a capacitance value of the touch screen has exceeded a pre-touch threshold to identify the pre-touch condition.

49. The medium of claim 48, wherein the pre-touch threshold is to be greater than a noise threshold and less than a touch threshold corresponding to the touch condition.
